(19) United States
(12) Patent Application Publication
(10) Pub. No.: US 2011/0209135 A1
(43) Pub. Date: Aug. 25, 2011

(54) Program Change Management Apparatus, Computer Readable Record Medium Storing Program Change Management Program, And Program Change Management Method

(75) Inventor: Haruhisa Sakuma, Kawasaki (JP)

(73) Assignee: FUJITSU LIMITED, Kawasaki-shi (JP)

(21) Appl. No.: 13/064,737

(22) Filed: Apr. 12, 2011

Related U.S. Application Data
(63) Continuation of application No. PCT/JP2008/068652, filed on Oct. 15, 2008.

(51) Int. Cl. G06F 9/44

(52) U.S. Cl. 717/170

(57) ABSTRACT

A before-change code read section included in a program change management apparatus reads out a before-change code stored in a before-change code storage section. An after-change code read section reads out an after-change code stored in an after-change code storage section. A change management information generation section generates change management information on the basis of the before-change code read out by the before-change code read section and the after-change code read out by the after-change code read section, and stores the change management information generated in a change management information storage section. A change management information output section outputs the change management information stored in the change management information storage section.

This application is a continuing application, filed under 35 U.S.C. §111(a), of International Application PCT/JP2008/068652, filed on Oct. 15, 2008.

### FIELD

The embodiment discussed herein is related to a program change management apparatus, a computer readable record medium storing a program change management program, and a program change management method.

### BACKGROUND

Formerly a version management technique, such as RCS (Revision Control System) or VSS (Visual SourceSafe), was used for managing a change in computer program source code. By using these systems, a group of pieces of source code which make up a software product can be managed by a revision uniquely given to it at a specific point of time or in a specific state. In addition, these systems can be used for extracting the difference between two revisions of program source code.

Furthermore, techniques disclosed in the following three documents are known regarding source code difference management:

Japanese Laid-open Patent Publication No. 05-80999

Japanese Laid-open Patent Publication No. 05-91550

Japanese Laid-open Patent Publication No. 05-158765

With the above techniques for managing a version of program source code, however, only source code text is managed. That is to say, the difference between two revisions of source code which can be extracted by these techniques is a result obtained by routinely comparing the two revisions of the source code as simple text files. In this case, the module structure or grammar of a computer language used is not considered at all. In addition, with these techniques a change portion in the two revisions is indicated only by a line number from the head. Furthermore, only a text deleted or added is indicated as the contents of a change with a line number as reference.

As a result, if, for example, the structure of a source code text file is reorganized and line numbers and the like are changed, there are cases where the difference between pieces of program source code cannot be reused. That is to say, another difference extracted on the basis of program source code in which a change other than the change by the reorganization is made before the reorganization cannot be used for applying the change to the source code text file after the reorganization.

### SUMMARY

According to an aspect of the present invention, there is provided a program change management apparatus including a before-change code storage section which stores a before-change code that is program code before a change, an after-change code storage section which stores an after-change code that is program code after the change, a change management information storage section which stores change management information indicative of contents of the change made in the before-change code, a before-change code read section which reads out the before-change code stored in the before-change code storage section, an after-change code read section which reads out the after-change code stored in the after-change code storage section, a change management information generation section which generates the change management information on the basis of the before-change code read out by the before-change code read section and the after-change code read out by the after-change code read section and which stores the, change management information generated in the change management information storage section, and a change management information output section which outputs the change management information stored in the change management information storage section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view for giving an overview of an embodiment;

FIG. 2 illustrates the hardware configuration of a source code management apparatus;

FIG. 3 is a block diagram of the source code management apparatus;

FIG. 4 is an example of before-change source code;

FIG. 5 is an example of after-change source code;

FIG. 6 illustrates an example of the structure of a change management table;

FIG. 7 illustrates an example of a difference file;

FIG. 8 illustrates input and output at difference file generation time;

FIG. 9 is a flow chart of a procedure for a change management information generation process;

FIG. 10 illustrates input and output at after-change source code generation time;

FIG. 11 is a flow chart of a procedure for an after-change code generation process; and

FIG. 12 is a flow chart of a procedure for an after-change code generation process.

### DESCRIPTION OF EMBODIMENTS

Embodiments will now be described with reference to the accompanying drawings, wherein like reference numerals refer to like elements throughout.

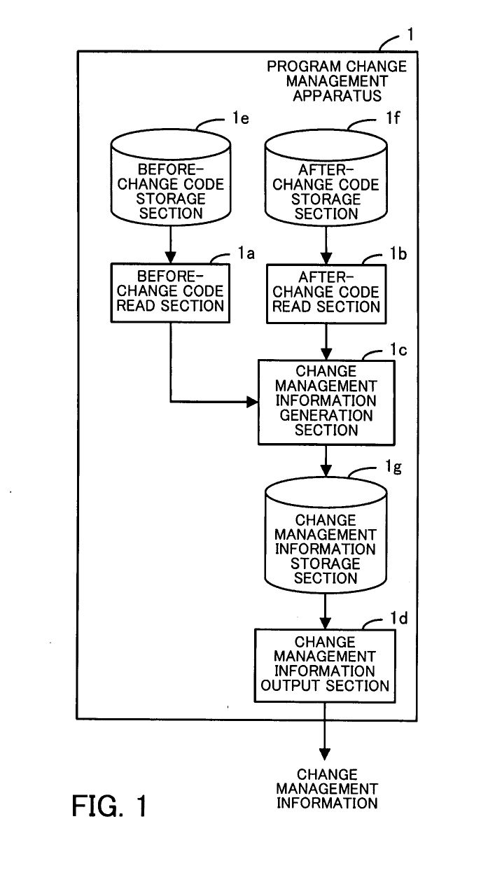

FIG. 1 is a view for giving an overview of an embodiment. A program change management apparatus 1 illustrated in FIG. 1 has a change management information generation function for generating change management information. The program change management apparatus 1 includes a before-change code read section 1a, an after-change code read section 1b, a change management information generation section 1c, a change management information output section 1d, a before-change code storage section 1e, an after-change code storage section 1f, and a change management information storage section 1g.

The before-change code read section 1a reads out a before-change code stored in the before-change code storage section 1e. A “change” means that a part of program code is corrected, for example, by making a revision through debug or version-up of a program.

The after-change code read section 1b reads out an after-change code stored in the after-change code storage section 1f.

The change management information generation section 1c generates change management information on the basis of the before-change code read out by the before-change code read section 1a and the after-change code read out by the after-change code read section 1b. The change management information generation section 1c then stores the change management information generated in the change management information storage section 1g. By doing so, the change management information generated can be used for changing the before-change code or another program code.

The change management information output section 1d outputs the change management information stored in the change management information storage section 1g. By doing so, another computer can change the before-change code or another program code by the use of the change management information outputted.

The before-change code storage section 1e stores the before-change code which is program code before a change. This before-change code is source code of a program such as a BIOS (Basic Input/Output System), an application, or an OS (Operating System).

In this case, there is no limit to the type of a program language under the condition that a corresponding portion of program code in which a change is made can be specified automatically. Accordingly, in this embodiment source code generated in a high-level language such as FORTRAN (registered trademark), COBOL (registered trademark), C language, C++, Java (registered trademark), or Lisp or assembly language can be managed.

Similarly, not only source code but also program code in executable form can be used under the condition that a corresponding portion of program code in which a change is made can be specified automatically.

A before-change code is generated by the use of another computer, is acquired from the outside by the program change management apparatus 1 on the basis of instructions from a user of the program change management apparatus 1 or a process by the program change management apparatus 1, and is stored in the before-change code storage section le. Alternatively, a before-change code stored in the before-change code storage section le may be generated by the use of the program change management apparatus 1.

The after-change code storage section if stores an after-change code which is program code after a change. For example, an after-change code and a before-change code are source code of the same program and the after-change code is revised program code obtained by debug, version-up, or the like of the before-change code. If the same change can be made, it is not necessary that the after-change code and the before-change code should be source code of the same program. It is assumed that the after-change code and the before-change code are generated in the same language.

An after-change code is generated by the use of another computer, is acquired from the outside by the program change management apparatus 1 on the basis of instructions from a user of the program change management apparatus 1 or a process by the program change management apparatus 1, and is stored in the after-change code storage section lf. This is the same with a before-change code. Alternatively, an after-change code stored in the after-change code storage section if may be generated by the use of the program change management apparatus 1.

The change management information storage section 1g stores change management information indicative of the contents of the change made in the before-change code. In this case, change management information is information indicative of the contents of a change made in a before-change code and the contents of the change are obtained by extracting the difference between the before-change code and the after-change code.

According to the above program change management apparatus 1, the before-change code read section 1a reads out a before-change code stored in the before-change code storage section 1e. The after-change code read section 1b reads out an after-change code stored in the after-change code storage section 1f. The change management information generation section 1c generates change management information on the basis of the before-change code and the after-change code and stores the change management information generated in the change management information storage section 1g. The change management information output section 1d outputs the change management information stored in the change management information storage section 1g.

By doing so, the change management information generation section 1c generates the change management information on the basis of the before-change code and the after-change code. As a result, a change in program code can be managed easily.

In addition, a change which is the same as the change from the before-change code to the after-change code can be made in another program code by the use of the change management information generated.

This embodiment will now be described in detail with reference to the drawings.

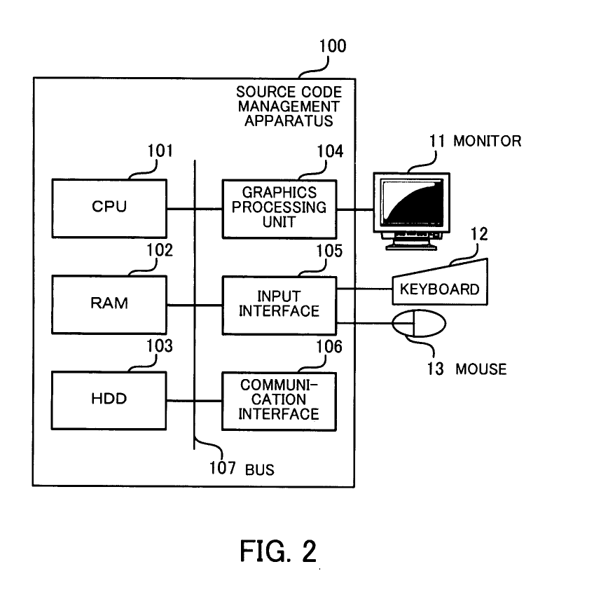

FIG. 2 illustrates the hardware configuration of a source code management apparatus. The whole of a source code management apparatus 100 illustrated in FIG. 2 is controlled by a CPU (Central Processing Unit) 101. A RAM (Random Access Memory) 102, a HDD (Hard Disk Drive) 103, a graphics processing unit 104, an input interface 105, and a communication interface 106 are connected to the CPU 101 via a bus 107.

The RAM 102 temporarily stores at least part of an OS program or an application program executed by the CPU 101. The RAM 102 also stores various pieces of data which the CPU 101 needs to perform a process. The HDD 103 stores the OS program and application programs.

A monitor 11 is connected to the graphics processing section 104. In accordance with instructions from the CPU 101, the graphics processing unit 104 displays an image on a screen of the monitor 11. A keyboard 12 and a mouse 13 are connected to the input interface 105. The input interface 105 transmits a signal transmitted from the keyboard 12 or the mouse 13 to the CPU 101 via the bus 107.

The communication interface 106 can be connected to a network (not illustrated). The communication interface 106 can exchange data with another computer via the network.

By adopting the above hardware configuration, processing functions in this embodiment can be realized.

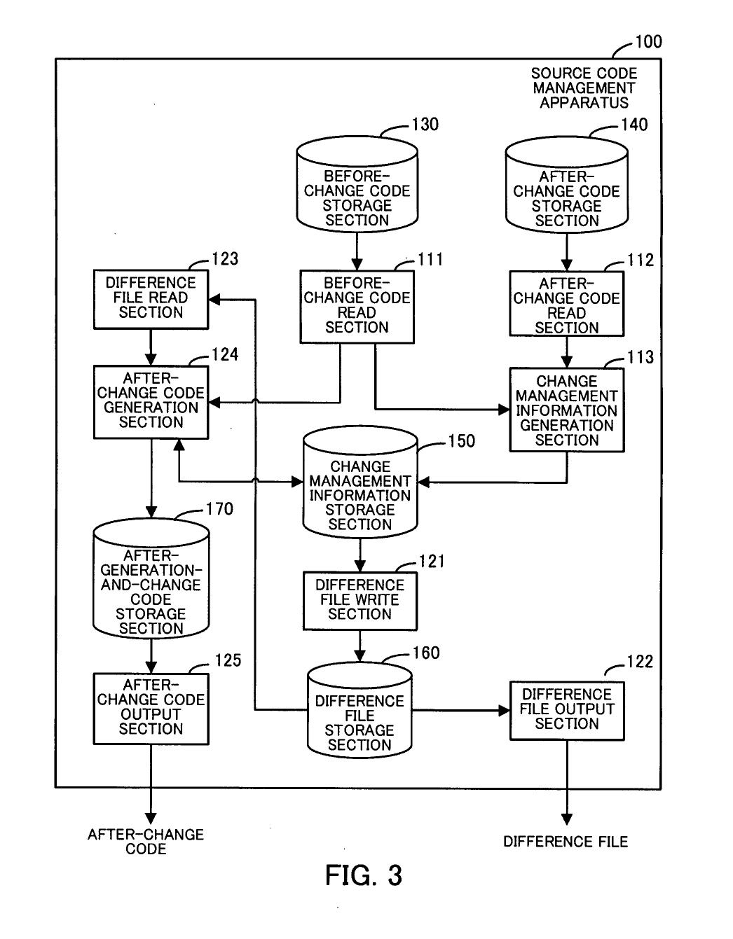

FIG. 3 is a block diagram of the source code management apparatus. The source code management apparatus 100 illustrated in FIG. 3 has a change management information generation function for generating change management information and an after-change code generation function for generating an after-change code. The source code management apparatus 100 includes a before-change code read section 111, an after-change code read section 112, a change management information generation section 113, a difference file write section 121, a difference file output section 122, a difference file read section 123, an after-change code generation section 124, an after-change code output section 125, a before-change code storage section 130, an after-change code storage section 140, a change management information storage section 150, a difference file storage section 160, and an after-generation-and-change code storage section 170.

The before-change code read section 111 reads out a before-change code stored in the before-change code storage section 130.

The after-change code read section 112 reads out an after-change code stored in the after-change code storage section 140.

On the basis of the before-change code read out by the before-change code read section 111 and the after-change code read out by the after-change code read section 112, the change management information generation section 113 generates change management information. The change management information generation section 113 then stores the change management information generated in the change management information storage section 150. By doing so, the change management information generated can be used for changing the before-change code or source code of another program.

The difference file write section 121 reads out change management information stored in the change management information storage section 150. On the basis of the change management information read out, the difference file write section 121 then generates a difference file which contains the change management information. After that, the difference file write section 121 stores the difference file generated in the difference file storage section 160.

The difference file output section 122 outputs a difference file stored in the difference file storage section 160. This difference file contains all or part of change management information stored in the change management information storage section 150. The difference file output section 122 outputs change management information in this way. Accordingly, the change management information outputted can be used on another computer for changing a before-change code or source code of another program. This difference file output section 122 functions as a change management information output unit.

The difference file read section 123 reads out a difference file which contains change management information and which is stored in the difference file storage section 160. This difference file read section 123 functions as a change management information read unit.

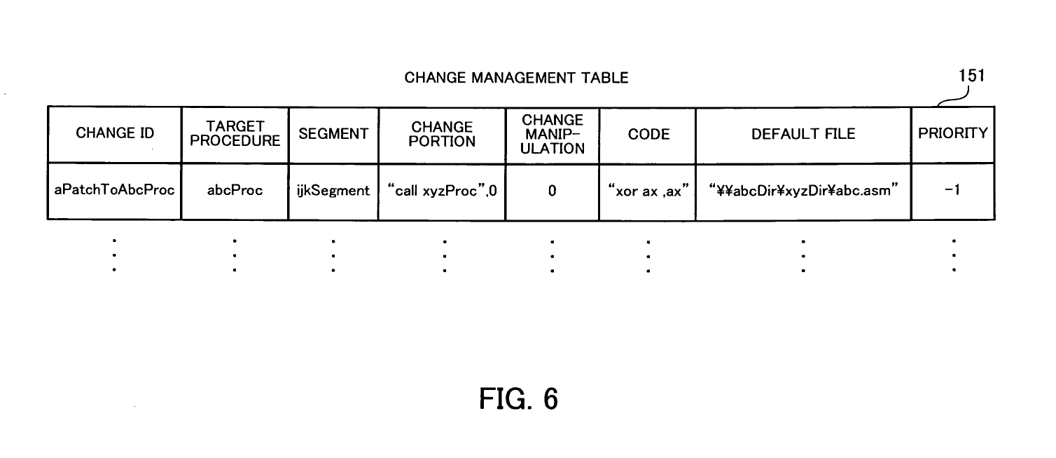

In this embodiment change management information is read out from the difference file storage section 160 by the difference file read section 123. However, change management information may be read out from the change management information storage section 150. In this case, change management information is read out directly from the change management information storage section 150 or is read out from a change management table (described later in FIG. 6).

On the basis of the before-change code read out by the before-change code read section 111 and the change management information read out by the difference file read section 123, the after-change code generation section 124 generates an after-generation-and-change code and stores the after-generation-and-change code generated in the after-generation-and-change code storage section 170.

The after-change code output section 125 outputs an after-generation-and-change code stored in the after-generation-and-change code storage section 170.

The before-change code storage section 130 stores a before-change code which is program source code before a change. This before-change code is source code of a program such as BIOS, an application, or an OS.

In this case, there is no limit to the type of a program language under the condition that a portion of a before-change code in which a change is to be made and a portion of an after-change code in which the change is made can be specified automatically. Accordingly, the source code management apparatus 100 according to this embodiment can manage source code generated in a high-level language such as FORTRAN, COBOL, C language, C++, Java, or Lisp or assembly language.

Similarly, not only source code but also program code in executable form can be used under the condition that a corresponding portion of program code in which a change is made can be specified automatically.

A before-change code is generated by the use of another computer, is acquired from the outside by the source code management apparatus 100 on the basis of instructions from a user of the source code management apparatus 100 or a process by the source code management apparatus 100, and is stored in the before-change code storage section 130. Alternatively, a before-change code stored in the before-change code storage section 130 may be generated by the use of the source code management apparatus 100.

The after-change code storage section 140 stores an after-change code which is program code after a change. This after-change code is source code of a program. This is the same with a before-change code. For example, an after-change code and a before-change code are source code of the same program and the after-change code is revised program source code obtained by version-up of the before-change code. If the same change can be made, it is not necessary that the after-change code and the before-change code should be source code of the same program. It is assumed that the after-change code and the before-change code are generated in the same language.

An after-change code is generated by the use of another computer, is acquired from the outside by the source code management apparatus 100 on the basis of instructions from a user of the source code management apparatus 100 or a process by the source code management apparatus 100, and is stored in the after-change code storage section 140. This is the same with a before-change code. Alternatively, an after-change code stored in the after-change code storage section 140 may be generated by the use of the source code management apparatus 100.

The change management information storage section 150 stores change management information indicative of the contents of a change made in a before-change code. In this case, change management information is information indicative of the contents of a change made in a before-change code and the contents of the change are obtained by extracting the difference between the before-change code and the after-change code.

The details of change management information will be described later in FIG. 6. Change management information includes change portion information indicative of a change portion of a before-change code in which a change is made in a code, change code information indicative of a change code used for making the change in the change portion of the before-change code, change manipulation information indicative of a change manipulation performed in the change portion of the before-change code, priority information indicative of change priority in the case of a plurality of changes being made in the same change portion of the before-change code, and the like. The “change manipulation” means the type of a manipulation performed in the change portion by a change. The “change manipulation” may be adding a code, deleting a code, correcting (overwriting) a code, or the like.

The difference file storage section 160 stores a difference file generated by the difference file write section 121 on the basis of change management information. This difference file contains all or part of change management information. The difference file storage section 160, together with the change management information storage section 150, functions as a change management information storage unit.

The after-generation-and-change code storage section 170 stores an after-generation-and-change code generated by making a change in a before-change code on the basis of change management information.

An example of source code used in this embodiment will now be described.

In this embodiment program code generated in assembly language for an Intel (registered trademark) ×86 series processor is used as an example of program code generated in a computer program language. However, the same applies to program code generated in another program language.

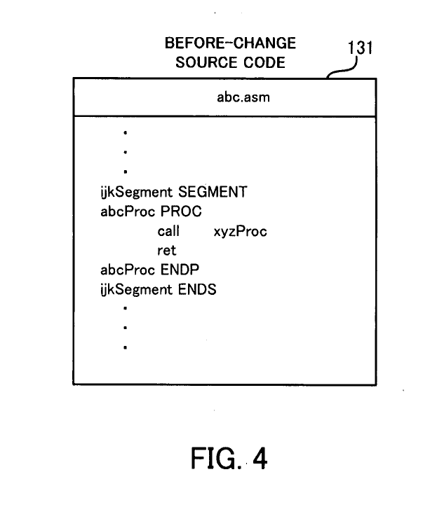

FIG. 4 is an example of before-change source code. Before-change source code (default source code) 131 indicated in FIG. 4 is arbitrary source code including a code which is an object of a change. In addition, a before-change source file indicative of the contents of the before-change source code 131 is stored in the HDD 103 which functions as the before-change code storage section 130.

In this embodiment the before-change source code 131 is stored in the HDD 103. However, the before-change source code 131 may be stored in the RAM 102 or another storage unit.

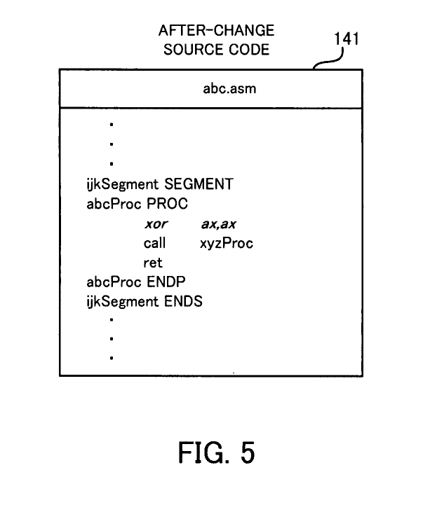

FIG. 5 is an example of after-change source code. After-change source code 141 indicated in FIG. 5 is source code after a change. In the example of FIG. 5, as indicated by thick italic characters, the line “xor ax, ax” is added between the line “abcProc PROC” and the line “call xyzProc,” compared with the before-change source code 131 illustrated in FIG. 4. In addition, an after-change source file indicative of the contents of the after-change source code 141 is stored in the HDD 103 which functions as the after-change code storage section 140.

In this embodiment the after-change source code 141 is stored in the HDD 103. However, the after-change source code 141 may be stored in the RAM 102 or another storage unit.

An example of the structure of data used in this embodiment will now be described.

FIG. 6 illustrates an example of the structure of a change management table. A change management table 151 illustrated in FIG. 6 is made and managed by the source code management apparatus 100 (described above in FIG. 2) and is stored in the HDD 103 (described above in FIG. 2). In this embodiment the HDD 103 functions as the change management information storage section 150. The change management table 151 stores change management information for defining the change from the before-change source code 131 to the after-change source code 141.

The change management table 151 includes Change ID, Target Procedure, Segment, Change Portion, Change Manipulation, Code, Default File, and Priority items. A Character string for uniquely specifying the change from the before-change source code 131 to the after-change source code 141 is set in the Change ID item. A procedure name assigned for uniquely specifying a procedure which is an object of the change is set in the Target Procedure item. The name of a segment to which the procedure changed belongs is set in the Segment item. Information for specifying a change portion in the procedure changed is set in the Change Portion item. The type of the change is set in the Change Manipulation item. A code used for making the change is set in the Code item. The name and location of a data file for the before-change source code 131 are set in the Default File item. Priority determined in the case of there being a plurality of changes is set in the Priority item. Pieces of information horizontally arranged in these items are associated with one another and make up change management information.

A character string is set as a change ID for identifying each change made in source code in a process performed by the source code management apparatus 100. An arbitrary character string can be used as a change ID. However, an arbitrary character string is set so that each change can be specified uniquely.

A target procedure indicates the name of a procedure which is an object of the change in the before-change source code 131 and the after-change source code 141. A segment indicates the name of a segment to which the procedure which is an object of the change belongs.

A change portion is information indicative of a change portion in the procedure which is an object of the change. In this embodiment a change portion includes a code near an object of the change and a value indicative of the relative position of the code and the object of the change. For example, the value “0” indicates that the object of the change comes before the code“. The value “1” indicates that the object of the change comes after the code”. The example of FIG. 6 indicates that an object of a change comes before “call xyzProc” illustrated in FIG. 5. However, a change portion may be set at need in arbitrary form so that a change portion will be specified.

A change manipulation is information indicative of the type of the change. “0” which indicates addition, which indicates deletion, “2” which indicates overwrite, or the like can be set as a change manipulation. However, a change manipulation may be set at need and the set change manipulation may be assigned to an arbitrary value.

A code is used for making the change in the target procedure. This code is used for making the change indicated by the change manipulation in the change portion of the target procedure.

A default file indicates the name and location of a data file for the before-change source code 131. In this case, a pathname for a data file for the before-change source code 131 is set.

If a plurality of changes are made in the same change portion, priority indicates their importance. For example, a change for which a higher priority value is set is more important. In this case, the ordinary value “−1” is set for an ordinary change. A higher value (such as “0,” “1,” or “2”) is set for a more important change according to the degree of the importance.

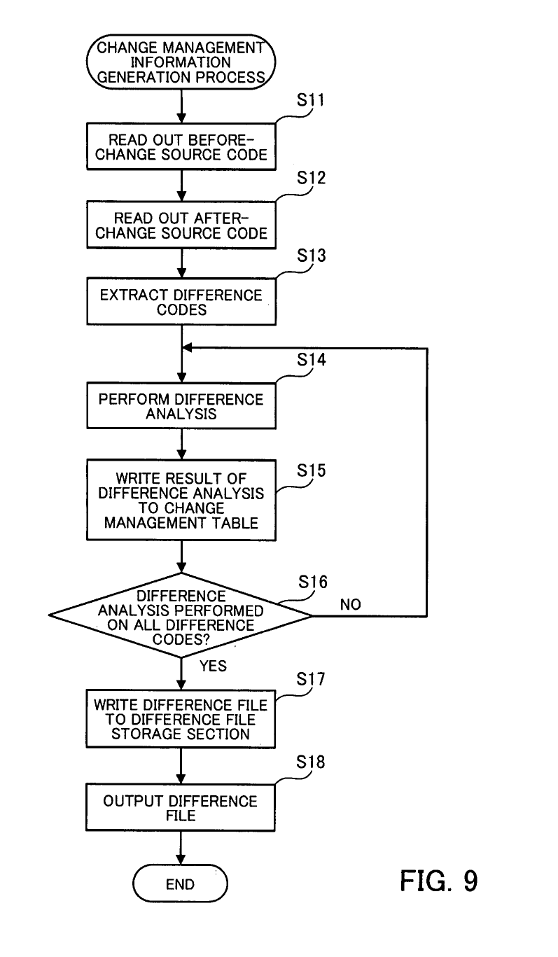

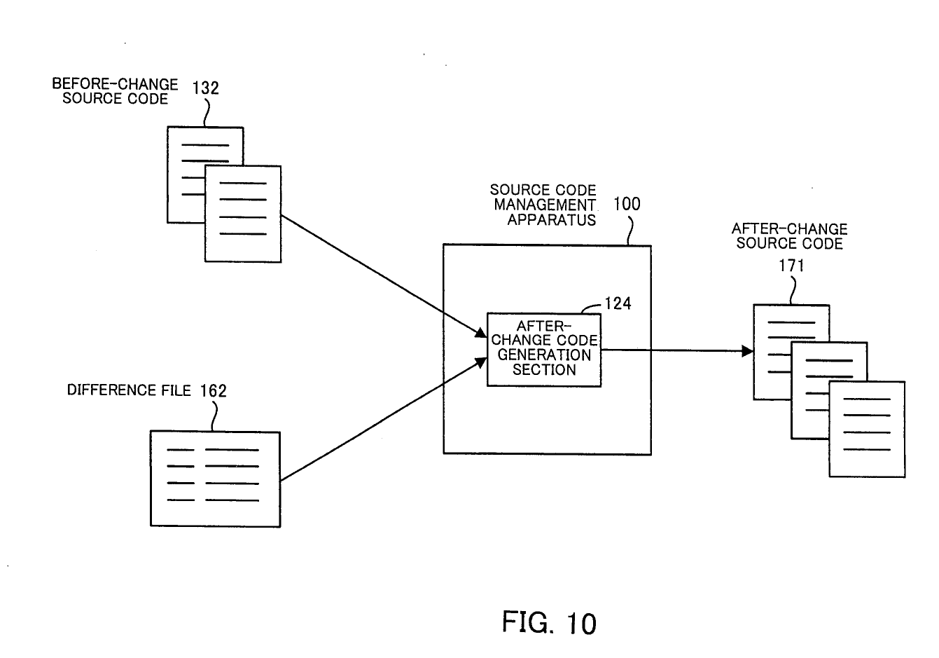

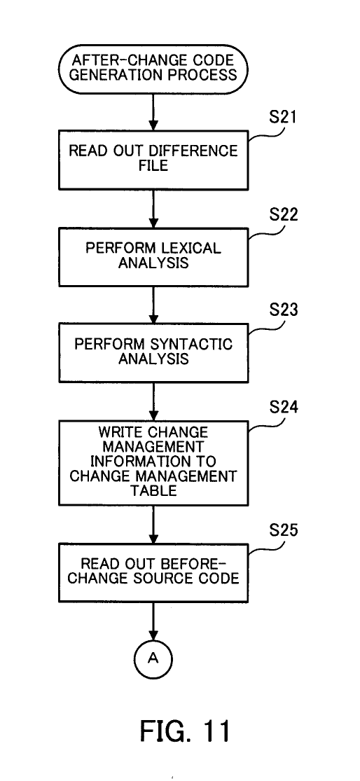

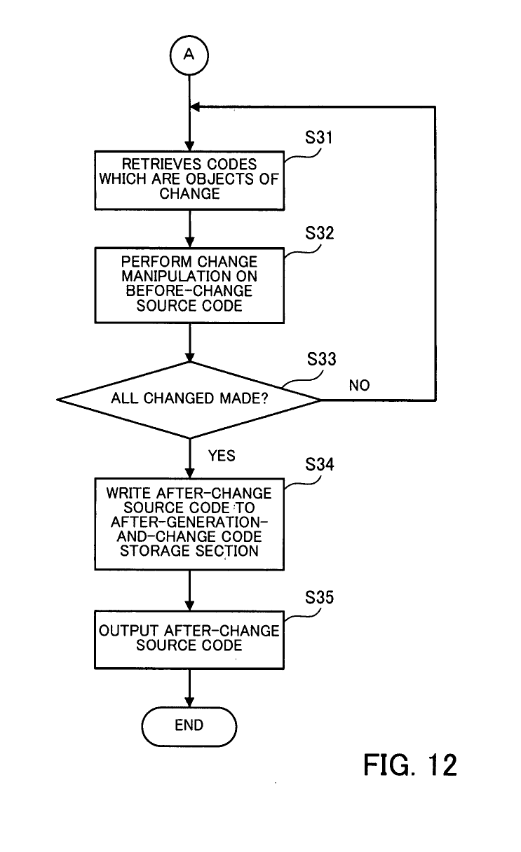

With the source code management apparatus 100 according to this embodiment change management information is generated in a change management information generation process (described later in FIG. 9) and is stored in the HDD 103. In addition, change management information is read out from the HDD 103 in an after-change code generation process (described later in FIGS. 11 and 12) and is used for generating after-change source code 171 (described later in FIG. 10).

In this embodiment the change management table 151 is stored in the HDD 103. However, the change management table 151 may be stored in the RAM 102 or another storage unit.

An example of a file used in this embodiment will now be described.

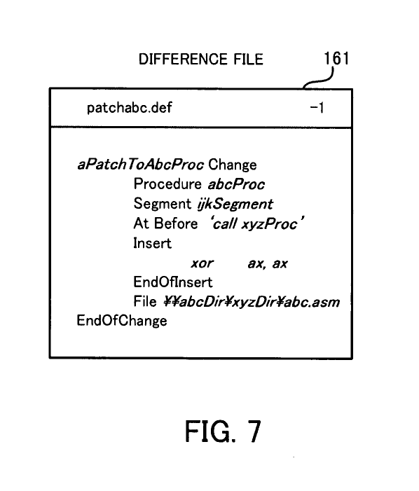

FIG. 7 illustrates an example of a difference file. A difference file 161 illustrated in FIG. 7 is generated on the basis of change management information (described above in FIG. 6) generated from the before-change source code 131 (described above in FIG. 4) and the after-change source code 141 (described above in FIG. 5), and contains the change management information. The difference file 161 is stored in the HDD 103 which functions as the difference file storage section 160.

The difference file 161 indicates a change in the procedure “abcProc” defined in the segment “ijkSegment” included in the before-change source code 131 described above in FIG. 4. The source code management apparatus 100 makes the change indicated in the difference file 161 in the before-change source code 131. By doing so, the after-change source code 171 (described later in FIG. 10) is generated.

In the difference file 161 a definition of a change is begun with the keyword “Change” in the first line and a unique name is given to the change. In addition, the end of the definition of the change is indicated by the keyword “EndOfChange” in the ninth line. In this example, the change the name of which is “aPatchToAbcProc” is defined by a block between “Change” in the first line and “EndOfChange” in the ninth line.

A procedure which is an object of the change is designated by the keyword “Procedure” in the second line.

This example indicates that a procedure the name of which is “abcProc” is changed.

A segment in which the procedure that is an object of the change is defined is designated by the keyword “Segment” in the third line. This example indicates that the procedure that is an object of the change is defined in a segment the name of which is “ijkSegment”.

A change portion is designated by the keyword “At Before” in the fourth line. This example indicates that a change portion comes before the code “call xyzProc”.

A manipulation performed in the change portion and a code after the change are indicated by a block from the fifth through seventh lines between the keywords “Insert” and EndOfInsert”. “Insert” indicates that the change is addition. In addition, “xor ax, ax” is indicated as an added code.

The name and location of a data file for the before-change source code 131 including an object of the change, that is to say, “abcProc” are indicated by the keyword “File” in the eighth line. In this example, a pathname for a data file for the before-change source code 131 is indicated.

Furthermore, priority is indicated in the upper right-hand portion of the difference file 161 illustrated in FIG. 7. In this example, priority is set to “−1”. For example, it is assumed that usually priority is set to “−1” and that priority for a higher priority change is set to a higher value (such as 0, 1, or 2). As a result, if a plurality of changes which are equal in object of change and change portion are defined, priorities of the plurality of changes made by the source code management apparatus 100 can be designated.

In this embodiment the difference file 161 is stored in the HDD 103. However, the difference file 161 may be stored in the RAM 102 or another storage unit.

Processes performed in this embodiment will now be described.

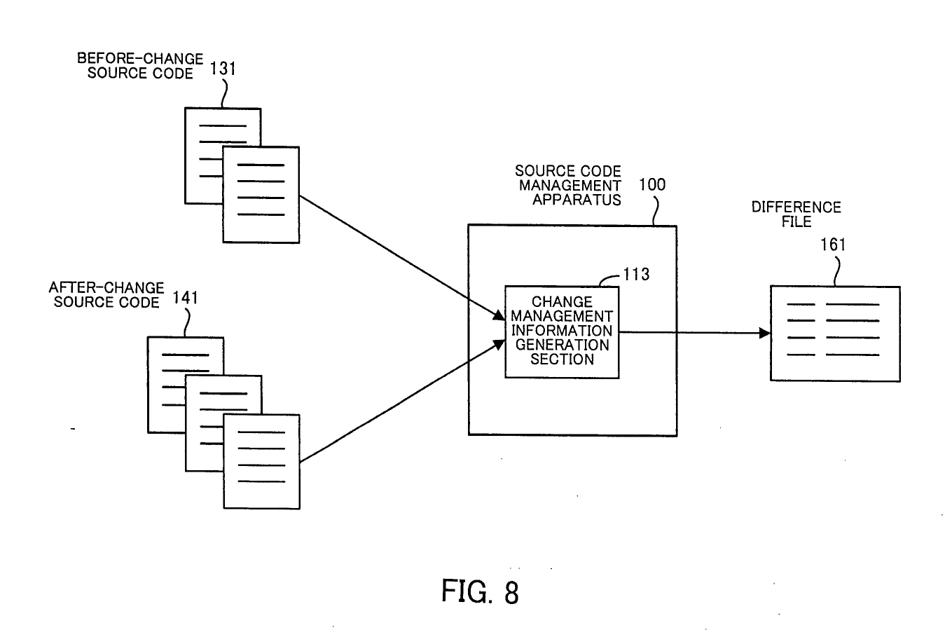

FIG. 8 illustrates input and output at difference file generation time. By performing a change management information generation process described later in FIG. 9, as illustrated in FIG. 8, the source code management apparatus 100 according to this embodiment outputs the difference file 161 (described above in FIG. 7) which the change management information generation section 113 generates with the data file for the before-change source code 131 (described above in FIG. 4) and a data file for the after-change source code 141 (described above in FIG. 5) as input.

FIG. 9 is a flow chart of a procedure for the change management information generation process. The change management information generation process illustrated in FIG. 9 is performed for outputting the difference file 161 (described above in FIG. 7) with the data file for the before-change source code 131 (described above in FIG. 4) and the data file for the after-change source code 141 (described above in FIG. 5) as input. The change management information generation process is performed, for example, when a user calls the change management information generation process by operating the keyboard 12, the mouse 13, or the like.

(Step S11) The before-change code read section 111 reads out the data file for the before-change source code 131 stored in the before-change code storage section 130 (described above in FIG. 3).

(Step S12) The after-change code read section 112 reads out the data file for the after-change source code 141 stored in the after-change code storage section 140 (described above in FIG. 3).

(Step S13) The change management information generation section 113 extracts difference codes from the before-change source code 131 read out in step S11 and the after-change source code 141 read out in step S12.

At this time the change management information generation section 113 extracts changed codes by comparing texts of the before-change source code 131 and the after-change source code 141.

(Step S14) The change management information generation section 113 performs a difference analysis on the basis of the difference codes extracted in step S13, and generates change management information.

This difference analysis will be described by the use of the before-change source code 131 and the after-change source code 141. In step S13, the change management information generation section 113 compares the texts of the before-change source code 131 illustrated in

FIG. 4 and the after-change source code 141 illustrated in FIG. 5, and extracts the difference codes. The change management information generation section 113 can obtain, from an extracted difference code, the result that the code “xor ax, ax” is added before the code “call xyzProc” in the procedure “abcProc”. In addition, the change management information generation section 113 can specify the segment “ijkSegment” to which the procedure “abcProc” belongs.

The change management information generation section 113 then assigns an arbitrary unique character string to each change and generates change management information with this character string as a change ID.

In addition, as described above, the change management information generation section 113 compares the texts of the before-change source code 131 and the after-change source code 141 and specifies a target procedure, a segment, a change portion, a change manipulation, and a code. By doing so, the change management information generation section 113 generates change management information.

Furthermore, the change management information generation section 113 generates a default file on the basis of file information regarding the data file for the before-change source code 131.

The change management information generation section 113 set priority to “−1” in the case of an ordinary change. When the change management information generation process is performed, the user may designate priority. For convenience of explanation one change is made in this embodiment. However, a plurality of changes may be made. In this case, the number of pieces of change management information generated corresponds to that of the plurality of changes.

(Step S15) The change management information generation section 113 writes the change management information obtained as a result of the difference analysis in step S14 to the change management table 151 (described above in FIG. 6) stored in the change management information storage section 150 (described above in FIG. 3).

(Step S16) The change management information generation section 113 determines whether the difference analysis in step S14 has been performed on the difference codes extracted in step S13. If the difference analysis has been performed on all the difference codes and there is no difference code on which the difference analysis has not been performed yet, then step S17 is performed next. On the other hand, if there is a difference code on which the difference analysis has not been performed yet, then step S14 is performed next.

(Step S17) The difference file write section 121 reads out the change management information written in step S15 to the change management table 151 stored in the change management information storage section 150. On the basis of the change management information read out, the difference file write section 121 then generates a difference file which contains the change management information. This difference file 161 is generated for each of the difference codes extracted from change portions in the change from the before-change source code 131 to the after-change source code 141. The difference file write section 121 then writes each difference file 161 generated to the difference file storage section 160 (described above in FIG. 3).

The difference file 161 is generated for each of the change portions in the change from the before-change source code 131 to the after-change source code 141. One difference file 161 may be generated for all the change portions in the change from the before-change source code 131 to the after-change source code 141.

Furthermore, one difference file 161 may be generated for each of groups into which all the change portions in the change from the before-change source code 131 to the after-change source code 141 are divided.

(Step S18) The difference file output section 122 reads out the difference file 161 which contains the change management information from the difference file storage section 160. The difference file output section 122 then outputs the difference file 161 read out. After that, the process ends.

FIG. 10 illustrates input and output at after-change source code generation time. By performing an after-change code generation process described later in FIGS. 11 and 12, as illustrated in FIG. 10, the source code management apparatus 100 according to this embodiment outputs a data file for after-change source code 171 generated by the after-change code generation section 124 with a data file for before-change source code 132 and a difference file 162 which contains all or part of change management information and which is a data file indicative of the contents of a change as input.

The before-change source code 132 is arbitrary source code including a code which is an object of a change. This is the same with the before-change source code 131 described above in FIG. 4.

The format of the difference file 162 is the same as that of the difference file 161 described above in

FIG. 7. The source code management apparatus 100 may generate the difference file 162 by performing a change management information generation process. However, the difference file 162 may be generated by another source code management apparatus 100 or the like and be prepared in advance. As a result, a user can change another version source code of the same program, source code of another program partially including the same codes, or the like by the use of a difference file generated by another user or a program supplier.

The after-change source code 171 is source code obtained by making a change in the before-change source code 132. This is the same with the after-change source code 141 described above in FIG. 5. As stated above, the change indicated in the difference file 162 is made in the before-change source code 132. By doing so, the after-change source code 171 is generated.

FIGS. 11 and 12 are flow charts of a procedure for an after-change code generation process. The after-change code generation process illustrated in FIGS. 11 and 12 performed for outputting the data file for the after-change source code 171 (described above in FIG. 10) with the data file for the before-change source code 132 (described above in FIG. 10) and the difference file 162 (described above in FIG. 10) as input. The after-change code generation process is performed, for example, when a user calls the after-change code generation process by operating the keyboard 12, the mouse 13, or the like.

(Step S21) The difference file read section 123 reads out the difference file 162 stored in the difference file storage section 160 (described above in FIG. 3).

(Step S22) The after-change code generation section 124 extracts a difference code from the difference file 162 read out in step S21. The after-change code generation section 124 then performs a lexical analysis on the difference code. As a result, the difference code described in the difference file 162 is extracted and a lexical analysis is performed on each code included in the extracted difference code.

In the lexical analysis the after-change code generation section 124 checks that a keyword, a name, or the like included in the difference code described in the difference file 162 is described correctly by the use of tokens set in accordance with, for example, the format illustrated in FIG. 6.

(Step S23) On the basis of the result of the lexical analysis performed in step S22, the after-change code generation section 124 performs a syntactic analysis on the difference code. As a result, a change ID, a target procedure, and the like included in change management information (described above in FIG. 6) are extracted from difference file description (described above in FIG. 7).

In the syntactic analysis the after-change code generation section 124 checks that the difference code described in the difference file 162 on the basis of tokens extracted in the lexical analysis is described correctly by the use of syntax set in accordance with, for example, the format illustrated in FIG. 6.

When the after-change code generation section 124 can check by the syntactic analysis that the difference code described in the difference file 162 is correct, the after-change code generation section 124 generates change management information indicative of the contents of a change interpreted in accordance with the above syntax. For convenience of explanation one change is made in this embodiment. However, a plurality of changes may be made. In this case, the number of pieces of change management information generated corresponds to that of the plurality of changes.

Change management information is generated in this way from contents described in the difference file 162 read out in step S21.

(Step S24) The after-change code generation section 124 writes the change management information obtained as a result of the syntactic analysis in step S23 to the change management table 151 (described above in FIG. 6) stored in the change management information storage section 150 (described above in FIG. 3).

(Step S25) The before-change code read section 111 reads out the data file for the before-change source code 132 stored in the before-change code storage section 130 (described above in FIG. 3).

In this case, the before-change code read section 111 can read out the before-change source code 132 on the basis of a default file included in the change management information.

(Step S31) On the basis of the change management information written to the change management table 151 (described above in FIG. 6), the after-change code generation section 124 retrieves codes which are objects of the change from the before-change source code 132 read out in step S25 (described above in FIG. 11), and selects one of the codes extracted by the retrieval. This selection is made in order from the head of the before-change source code 132. However, if there are a plurality of changes, selection can be made in order set by an arbitrary method.

(Step S32) The after-change code generation section 124 performs a change manipulation indicated in the change management information written to the change management table 151 on the code retrieved in step S31 from the before-change source code 132 read out in step S25.

In the change manipulation the after-change code generation section 124 acquires the before-change source code 132 read out by the before-change code read section 111 on the basis of the default file included in the change management information, and retrieves the code which is an object of the change from the before-change source code 132 on the basis of the target procedure and the segment.

If the after-change code generation section 124 can find the code which is an object of the change by the retrieval, then the after-change code generation section 124 performs the change manipulation in a change portion in which the change is made by the use of the code. In the example of this embodiment “xor ax, ax” is added before “call xyzProc”.

There may be a plurality of change manipulations in the same portion of the source code which is an object of the change. In this case, the after-change code generation section 124 does not perform a change manipulation when a higher priority change manipulation has already been performed. This can prevent a conflict between change manipulations.

(Step S33) The after-change code generation section 124 determines whether or not all changes indicated in the change management information written to the change management table 151 have been made. If all the changes have been made, then step S34 is performed next.

On the other hand, if there is a change which has not been made yet, then step S31 is performed next.

(Step S34) The after-change code generation section 124 writes the after-change source code 171 obtained as a result of the change manipulation in step S32 to the after-generation-and-change code storage section 170 (described above in FIG. 3). As a result, all of the change manipulations indicated in the difference file 162 have been performed in the after-change source code 171.

(Step S35) The after-change code output section 125 reads out the after-change source code 171 generated in step S34 from the after-generation-and-change code storage section 170. The after-change code output section 125 then outputs the after-change source code 171 read out. After that, the process ends.

The source code management apparatus 100 according to this embodiment has the above change management information generation function and after-change code generation function. However, the source code management apparatus 100 may have only one of the change management information generation function and the after-change code generation function.

As a result, a software maker or the like can generate change management information for each object of a change from a before-change code and an after-change code by the use of a computer having the change management information generation function, and distribute it among users and the like.

According to this embodiment, as has been described in the foregoing, the change management information generation section 113 generates change management information on the basis of a before-change code and an after-change code. By using the change management information, each change can be managed independently and the influence of another change can be excluded. Therefore, a change in program source code can be managed easily.

In addition, change management information is generated independently according to change. Accordingly, change management information corresponding to each of changes made independently of one another in different portions of the same program can be used for changing a before-change code.

If source code of another program includes the same segment, a change which is the same as the change from a before-change code to an after-change code can be made easily by the use of change management information generated. Furthermore, even if a change is made in source code of another program, a segment and a change portion in the segment are specified by change portion information. Therefore, the change can be made automatically.

Moreover, change management information includes priority information indicative of the priority of a change. Therefore, even if a plurality of changes are made in the same portion of source code, adjustment can be made in advance among the plurality of changes by properly setting their priorities in advance.

The above functions can be realized with a computer. In this case, a program in which the contents of the functions the source code management apparatus 100 should have are described is provided. By executing this program on the computer, the above functions are realized on the computer.

This program can be recorded on a computer readable record medium. A computer readable record medium can be a magnetic recording device, an optical disk, a magneto-optical recording medium, a semiconductor memory, or the like. A magnetic recording device can be HDD, a FD (Flexible Disc), a MT (magnetic tape), or the like. An optical disc can be a DVD (Digital Versatile Disc), a DVD-RAM, a CD-ROM (Compact Disc-Read Only Memory), CD-R(Recordable)/RW(ReWritable), or the like. A magneto-optical recording medium can be a MO (Magneto-Optical disk) or the like.

To place the program on the market, portable record media, such as DVDs or CD-ROMs, on which it is recorded are sold. Alternatively, the program is stored in advance in a server computer and is transferred from the server computer to another computer via a network.

When the computer executes this program, it will store the program, which is recorded on a portable record medium or which is transferred from the server computer, in, for example, its storage device. Then the computer reads the program from its storage device and performs processes in compliance with the program. The computer can also read the program directly from a portable record medium and perform processes in compliance with the program. Furthermore, each time the program is transferred from the server computer, the computer can perform processes in turn in compliance with the program it receives.

According to the disclosed program change management apparatus and a computer readable record medium storing the program change management program, each change in program can be managed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that various changes, substitutions, and alterations could be made hereto without departing from the spirit and scope of the invention.

What is claimed is:

1. A program change management apparatus comprising:
a before-change code storage section which stores a before-change code that is program code before a change;
an after-change code storage section which stores an after-change code that is program code after the change;
a change management information storage section which stores change management information indicative of contents of the change made in the before-change code;
a before-change code read section which reads out the before-change code stored in the before-change code storage section;
an after-change code read section which reads out the after-change code stored in the after-change code storage section;
a change management information generation section which generates the change management information on the basis of the before-change code read out by the before-change code read section and the after-change code read out by the after-change code read section, and stores the change management information generated in the change management information storage section; and
a change management information output section which outputs the change management information stored in the change management information storage section.

2. The program change management apparatus according to claim 1 further comprising:
an after-generation-and-change code storage section which stores an after-generation-and-change code generated as a result of making the change in the before-change code on the basis of the change management information;
a change management information read section which reads out the change management information stored in the change management information storage section;
an after-change code generation section which generates the after-change code on the basis of the before-change code read out by the before-change code read section and the change management information read out by the change management information read section, and stores the after-change code generated in the after-generation-and-change code storage section; and
an after-change code output section which outputs the after-generation-and-change code stored in the after-generation-and-change code storage section.

3. The program change management apparatus according to claim 1, wherein the change management information includes:
change portion information indicative of a change portion of the before-change code in which the change is made in a code; and
change code information indicative of a change code used for making the change in the change portion of the before-change code.

4. The program change management apparatus according to claim 3, wherein the change management information includes change manipulation information indicative of a change manipulation performed in the change portion of the before-change code.

5. The program change management apparatus according to claim 3, wherein the change management information includes priority information indicative of change priority in the case of a plurality of changes being made in the same change portion of the before-change code.

6. The program change management apparatus according to claim 1, wherein the program code is source code.

7. A program change management apparatus comprising:
a before-change code storage section which stores a before-change code that is program code before a change;
a change management information storage section which stores change management information indicative of contents of the change made in the before-change code;
an after-generation-and-change code storage section which stores an after-generation-and-change code generated as a result of making the change in the before-change code on the basis of the change management information;
a before-change code read section which reads out the before-change code stored in the before-change code storage section;
a change management information read section which reads out the change management information stored in the change management information storage section;
an after-change code generation section which generates the after-generation-and-change code on the basis of the before-change code read out by the before-change code read section and the change management information read out by the change management information read section, and stores the after-generation-and-change code generated in the after-generation-and-change code storage section; and
an after-change code output section which outputs the after-generation-and-change code stored in the after-generation-and-change code storage section.

8. A computer-readable, non-transitory record medium storing a program change management program, the program making a computer function as:
a before-change code read section which reads out a before-change code that is program code before a change and that is stored in a before-change code storage section;
an after-change code read section which reads out an after-change code that is program code after the change and that is stored in an after-change code storage section;
a change management information generation section which generates change management information indicative of contents of the change made in the before-change code on the basis of the before-change code read out by the before-change code read section and the after-change code read out by the after-change code read section, and stores the change management information generated in a change management information storage section; and
a change management information output section which outputs the change management information stored in the change management information storage section.

9. A program change management method comprising:
reading out, by a before-change code read section, a before-change code that is program code before a change and that is stored in a before-change code storage section;
reading out, by an after-change code read section, an after-change code that is program code after the change and that is stored in an after-change code storage section;
generating, by a change management information generation section, change management information indicative of contents of the change made in the before-change code on the basis of the before-change code read out by the before-change code read section and the after-change code read out by the after-change code read section, and storing, by the change management information generation section, the change management information generated in a change management information storage section; and
outputting, by a change management information output section, the change management information stored in the change management information storage section.
